(19) United States
(12) Patent Application Publication
(10) Pub. No.: US 2008/0089225 A1
(43) Pub. Date: Apr. 17, 2008

(54) Methods, systems, and computer program products for generating network outage reports

(76) Inventors: Felix Ammay, Kings Mountain, NC (US); Jackie Walker, Charlotte, NC (US); Janice Darty, Cumming, GA (US); Roy Allen, Cherryville, NC (US)

Correspondence Address: CANTOR COLBURN LLP - BELLSOUTH, 20 Church Street, 22nd Floor, Hartford, CT, 06103, US

(21) Appl. No.: 11/546,686

(22) Filed: Oct. 12, 2006

(51) Int. Cl. H04J 1/16

(52) U.S. Cl. 370/216

(57) ABSTRACT

Methods, systems, and computer program products for generating network outage reports. The methods include receiving alarm data for a network outage which, if not remedied, may become a reportable event. The alarm data includes a plurality of alarm records each including a site identifier, a date, a time, and an outage event description. The alarm records are processed to determine outage information comprising at least one of a current outage duration or a current quantity of lines affected by the outage. A reportable event threshold defines at least one of a minimum reportable outage duration or a minimum reportable quantity of lines affected by the outage. If the current outage duration is greater than the minimum reportable outage duration, or if the current quantity of lines affected by the outage is greater than the minimum reportable quantity of lines affected by the outage, or both, then a network outage report is generated which associates the network outage with a graphical indicia.

### BACKGROUND

Exemplary embodiments relate generally to networks, and more particularly, to methods, systems and computer program products for generating network outage reports.

Network providers strive to provide high levels of reliability and quality of service to their customers. During system failure situations, such as those encountered during storms, workers in the field and others are aided in performing network verification and recovery by utilizing related outage information. Network outage information may include, for example, information pertaining to remote terminal/digital loop carrier (RT/DLC) system failures, digital loop carriers (DLCs) without commercial power, failed asymmetric digital subscriber line (ADSL) equipment, broadband customer out of service (OOS), simplex and failed carrier systems, signaling system seven (SS7) links affected, and central offices (COs) on emergency generator or battery power.

If a network outage reaches a critical level as determined by the duration of the outage, the number of working lines affected by the outage, or other outage-related parameters, the outage must be reported to the Federal Communications Commission (FCC). More specifically, the network provider must file a report with the Federal Communications Commission (FCC) summarizing the extent of damage to network provider equipment and consequent effects on customer service. Accordingly, it would be desirable to correct a network outage before the outage becomes an FCC-reportable event.

At present, network outage information is gathered using a variety of automated and non-automated methods. Alarm data is printed and examined line-by-line by numerous individuals to determine equipment status. This process is very tedious and time consuming. A summary of equipment status is then faxed or emailed to field workers. For a large network provider, the fax could become over a hundred pages in length.

The information presented in existing equipment status summaries do not enable a quick, efficient determination as to whether an existing network outage is about to become a reportable event. Field workers and others are unable to ascertain which network outages listed in the status summaries must be remedied as soon as possible to avoid occurrence of a reportable event, in contrast to other network outages which may not result in a reportable event for quite some time. What is needed is a report that provides information for a plurality of network outages that, if not corrected, may become FCC reportable events.

### SUMMARY

Exemplary embodiments relate to methods, systems, and computer program products for generating network outage reports. The methods include receiving alarm data for a network outage which, if not remedied, may become a reportable event. The alarm data includes a plurality of alarm records each including a site identifier, a date, a time, and an outage event description. The alarm records are processed to determine outage information comprising at least one of a current outage duration or a current quantity of lines affected by the outage. A reportable event threshold defines at least one of a minimum reportable outage duration or a minimum reportable quantity of lines affected by the outage. If the current outage duration is greater than the minimum reportable outage duration, or if the current quantity of lines affected by the outage is greater than the minimum reportable quantity of lines affected by the outage, or both, then a network outage report is generated which associates the network outage with a graphical indicia.

Computer program products for generating network outage reports include a storage medium readable by a processing circuit and storing instructions for execution by the processing circuit for facilitating a method. The method includes receiving alarm data for a network outage which, if not corrected, may become a reportable event. The alarm data includes a plurality of alarm records each including a site identifier, a date, a time, and an outage event description. The alarm records are processed to determine outage information comprising at least one of a current outage duration or a current quantity of lines affected by the outage. A reportable event threshold defines at least one of a minimum reportable outage duration or a minimum reportable quantity of lines affected by the outage. If the current outage duration is greater than the minimum reportable outage duration, or if the current quantity of lines affected by the outage is greater than the minimum reportable quantity of lines affected by the outage, or both, then a network outage report is generated which associates the network outage with a graphical indicia.

Systems for generating network outage reports include an output mechanism and a processor in communication with the output mechanism, the processor including instructions for receiving alarm data from a plurality of sources for a network outage which, if not corrected, may become a reportable event. The alarm data includes a plurality of alarm records each including a site identifier, a date, a time, and an outage event description. The alarm records are processed to determine network outage information comprising at least one of a current network outage duration or a current quantity of lines affected by the network outage. A reportable event threshold defines at least one of a minimum reportable outage duration or a minimum reportable quantity of lines affected by the network outage. If the current outage duration is greater than the minimum reportable outage duration, or if the current quantity of lines affected by the outage is greater than the minimum reportable quantity of lines affected by the outage, or both, then a network outage report is generated which associates the network outage with a graphical indicia.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of an exemplary system that may be utilized to provide consolidated network outage information;

FIG. 2 is a flow diagram of an exemplary process for providing consolidated network outage information;

FIG. 3 depicts exemplary attributes for alarm data;

FIG. 4 is an exemplary user interface illustrating a home page for a network reliability center (NRC) storm reporter system;

FIG. 5 is an exemplary user interface including a summary report of network outages for a selected state;

FIG. 6 is an exemplary user interface including a detailed report for all digital loop carriers (DLCs) in a selected state;

FIG. 7 is an exemplary user interface for DLCs failed or on batteries;

FIG. 8 is an exemplary user interface for viewing DLC alarms;

FIG. 9 is an exemplary user interface for viewing a list of predefined filters/reports;

FIG. 10 is an exemplary user interface for viewing central offices on emergency power that have been selected to be included in a report;

FIG. 11 is an exemplary user interface for allowing users to search for field work group (FWG) turf districts;

FIG. 12 is an exemplary user interface for advanced storm reporter functions only available to authorized users in exemplary embodiments;

FIG. 13 is an exemplary user interface for searching alarms by entity type;

FIG. 14 is an exemplary user interface for viewing selected live DLC alarms;

FIG. 15 is an exemplary user interface for viewing and creating filters/reports;

FIG. 16 is an exemplary user interface for viewing data relating to open and/or closed events and for accessing archived data;

FIG. 17 is an exemplary user interface of archived data;

FIG. 18 is an exemplary user interface for inserting central office engine transfer and battery discharge alarms into a central office report;

FIG. 19 is an exemplary user interface for manually entering central office engine transfer and battery discharge alarms for reporting;

FIG. 20 is an exemplary user interface for updating and entering carrier levels;

FIG. 21 is an exemplary user interface showing an illustrative network outage report; and

FIGS. 22A-22B together comprise an exemplary flowchart setting forth a process by which the network outage report of FIG. 21 may be generated.

### DETAILED DESCRIPTION OF EXEMPLARY EMBODIMENTS

Exemplary embodiments are directed to network outage reporting. Although the description below discusses outages caused by storms, it should be appreciated that the invention is applicable to any type of network outage, such as outages due to construction, outages caused by hardware failure, outages caused by software interoperability issues, and other types of failures.

According to exemplary embodiments, alarm data collection and site status determination are performed in an expeditious manner. The status of a particular site may be utilized to assign network provider field resources and/or to provide status updates to the Federal Communications Commission (FCC) and other government agencies. Exemplary embodiments collect and process selected alarm data to determine the number and nature of the alarms. The results may be output in several formats including: a totals view report which contains summary information for several types of equipment; a totals view report which contains summary information about a particular type of equipment (e.g., a digital loop carrier (DLC) totals view report); a detailed view report that contains detailed information for several types of equipment (e.g. a digital equipment systems specialist (DESS) detailed view report); and a detailed view that contains detailed information for a particular type of equipment. In addition, custom and on-demand reports may be provided along with links to weather information and administrative tools.

Exemplary embodiments provide the ability to summarize network carrier equipment status and other storm related alarm information in one location. For example, the network carrier equipment status could refer to the status of a DLC. The status of DLCs may be critical for emergency generator deployment. In addition, the network provider has the ability to create virtually real time reports (e.g., within a user modifiable period of time from the creation of the alarms) for equipment restoration as well as reporting purposes.

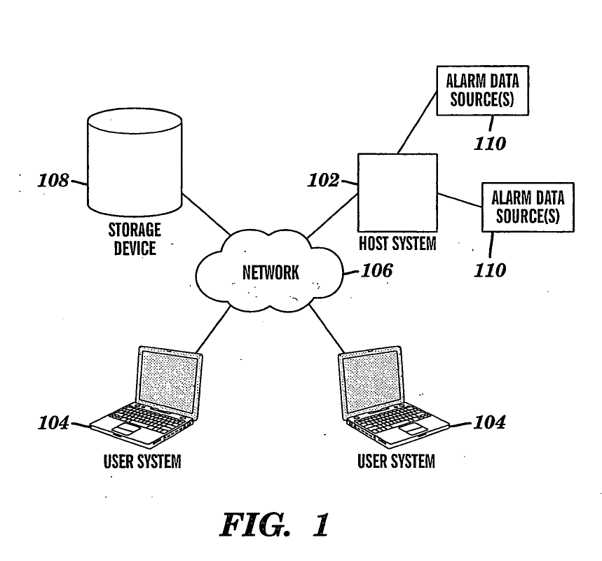

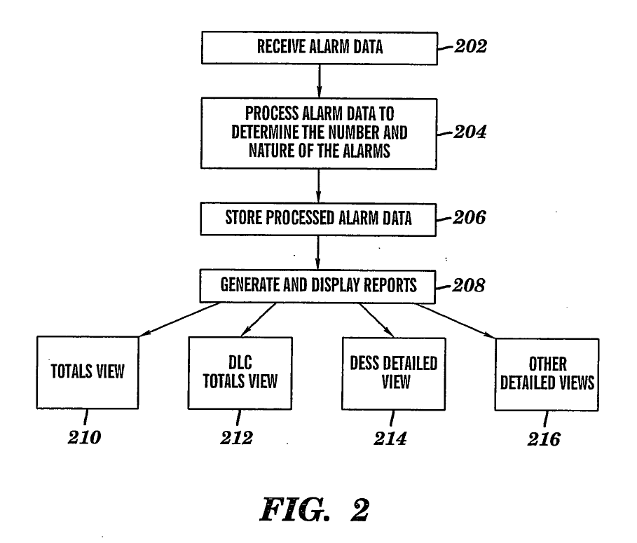

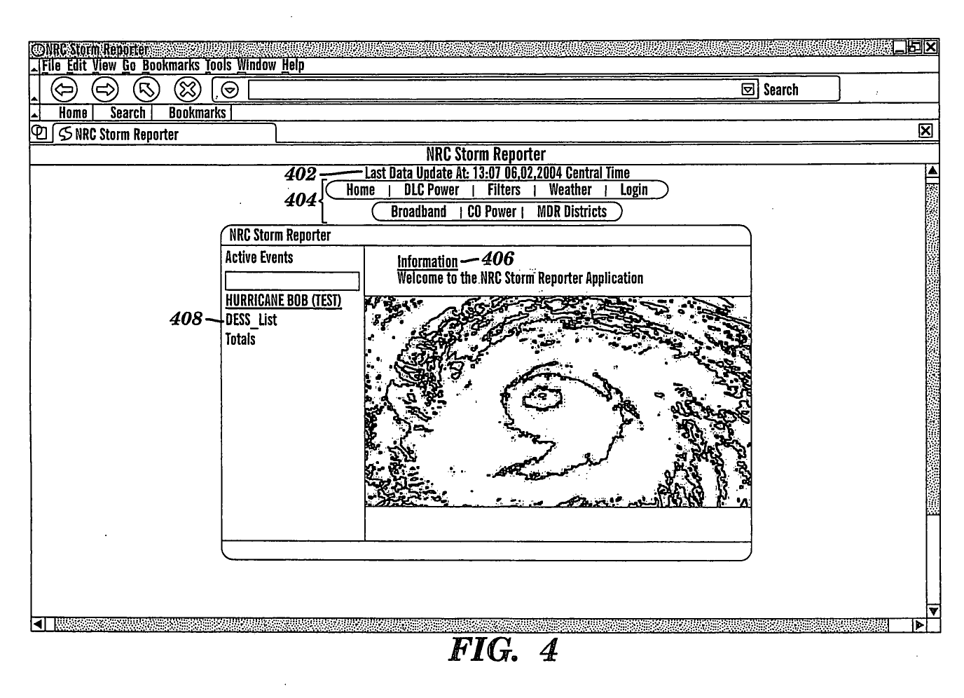

FIG. 1 is a block diagram of an exemplary system that may be utilized to provide consolidated network outage information. The system depicted in FIG. 1 includes one or more user systems 104, through which users at one or more geographic locations may contact the host system 104 to perform reporting of network outages as may occur, for example, in connection with a storm or other weather-related event. The user systems 104 (also referred to herein as user devices) may be utilized to display the user interfaces, such as those depicted in FIGS. 4-18. The host system 102 executes computer instructions for implementing, receiving, and/or retrieving alarm data associated with network outages, processing the alarm data to create report data and generating reports based on the report data as described herein (see for example, FIG. 2 and the accompanying description). The user systems 104 are coupled to the host system 102 via a network 106. Each user system 104 may be implemented using a general-purpose computer executing a computer program for carrying out the processes described herein. The user systems 104 may be implemented by personal computers and/or host attached terminals. If the user systems 104 are personal computers (e.g., laptop, personal digital assistant), the processing described herein may be shared by a user system 104 and the host system 102 (e.g., by providing an applet to the user system).

The alarm data sources 110 may include a network event reporting system (NERS) tool used by a network reliability center (NRC), illustratively implemented using commercially available network monitoring software such as the Telcordia NMA System and/or software created specifically for an/or by the network provider. The NERS tool retrieves facility, switch, emergency 911 (E911), and work management center (WMC) event outage information from an event ticketing system. The alarm data sources 110 may also include a customer incident measurement system (CIMS). CIMS is an event management system that monitors dedicated high capacity circuits for outages.

Pursuant to exemplary embodiments, the alarm data is generated by the NERS tool and CIMS. Pursuant to other exemplary embodiments, the alarm data is generated by a single alarm data source. In other alternate exemplary embodiments, different kinds of alarms are generated by different alarm data sources 110. In addition, errors for different kinds of conditions and/or equipment may be generated by different alarm data sources 110. For example, alarms relating to DLC equipment may be received from an alarm data source 110 such as the Telcordia NMA System and alarms relating to asymmetric digital subscriber lines (ADSLs) may be received from an alarm data source 110 that was developed and is specific to the network provider. In addition, the alarm data sources 110 may be directly connected to the host system 102 (as depicted in FIG. 1) or via a network 106.

The network 106 may be any type of known network including, but not limited to, a wide area network (WAN), a local area network (LAN), a global network (e.g. Internet, cellular), a virtual private network (VPN), and an intranet. The network 106 may be implemented using a wireless network or any kind of physical network implementation. A user system 104 may be coupled to the host system through multiple networks (e.g., intranet and Internet) so that not all user systems 104 are coupled to the host system 102 through the same network. One or more of the user systems 104 and the host system 102 may be connected to the network 106 in a wireless fashion.

The storage device 108 includes the report data (both current and historical) and any other data related to network outage reporting (e.g., time of last update). The storage device 108 may be implemented using a variety of devices for storing electronic information. It is understood that the storage device 108 may be implemented using memory contained in the host system 102, a user system 104, or it may be a separate physical device. The storage device 108 is logically addressable as a consolidated data source across a distributed environment that includes a network 106. Information stored in the storage device 108 may be retrieved and manipulated via the host system 102 and/or via one or more user systems 104. In exemplary embodiments, the host system 102 operates as a database server and coordinates access to report data including data stored on the storage device 108.

The host system 102 depicted in FIG. 1 may be implemented using one or more servers operating in response to a computer program stored in a storage medium accessible by the server. The host system 102 may operate as a network server (e.g., a web server) to communicate with the user systems 104. The host system 102 handles sending and receiving information to and from the user system 104 and can perform associated tasks. The host system 102 may also include a firewall to prevent unauthorized access to the host system 102 and enforce any limitations on authorized access. A firewall may be implemented using conventional hardware and/or software in a manner those skilled in the art would appreciate.

The host system 102 may also operate as an application server. The host system 102 executes one or more computer programs to perform the processing and reporting described herein (see for example, FIG. 2). Processing may be shared by the user system 104 and the host system 102 by providing an application (e.g., java applet) to the user system 104.

Alternatively, the user system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

FIG. 2 is a flow diagram of an exemplary process for providing consolidated network outage information. At block 202, alarm data from alarm data source(s) 110 is received at a host system 102. In exemplary embodiments, the alarm data is received in response to a request from the host system 102. In alternate embodiments, the alarm data source(s) 110 automatically send data on a periodic basis or in response to an event occurring (e.g., a new alarm). At block 204, the alarm data is processed to determine the number and nature of the alarms. At block 206, the processed alarm data (also referred to herein as report data) is stored in the storage device 108.

At block 208 in FIG. 2, reports are generated and displayed (e.g., on user systems 104 via the user interfaces described herein). In exemplary embodiments, the reports are generated and displayed in response to a particular request from a requestor. In alternate embodiments, the reports are generated automatically and displayed in response to a particular request from a requester. In exemplary embodiments, the reports include, but are not limited to: a totals view report 210 which contains summary information for several types of equipment; a DLC totals view report 212 which contains summary information for DLC equipment; a DESS detailed view report 214 that includes detailed information for several types of equipment and other detailed view reports 216 that contain detailed information for a particular type of equipment (e.g., signaling system seven (SS7), DLC, digital subscriber line access multiplexer (DSLAM).

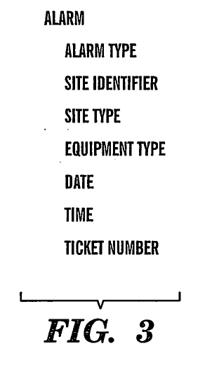

FIG. 3 depicts exemplary attributes for alarm data. In exemplary embodiments, the alarm data attributes include: alarm type (e.g., out of service, power outage, on batteries, on engines and critical); site identifier (which correlates to one geographic regions such as turf and state); site type (e.g., central office (CO), customer and carrier); equipment type (e.g., DLC, ADSL, simplex, SS7, DSLAM); date; time and ticket number (FWG has been assigned to fix the alarm condition). In exemplary embodiments, the site identifier is the common language location identifier (CLLI), a unique site identifier. The attributes depicted in FIG. 3 are meant to be exemplary in nature and any attributes collected by alarm data sources 110 may be added to the alarm data attributes.

FIG. 4 is an exemplary user interface illustrating a home page for a network reliability center (NRC) storm reporter system. The storm reporter system may be utilized by network provider personnel such as network reliability center (NRC) staff, field work groups (FWGs), DESSs and other network personnel to identify network outages and to determine equipment (e.g., DLC) status (e.g., loss of commercial power and/or failed sites). In addition, exemplary embodiments may be utilized to search ticket number data for central office engine transfer and battery discharge alarms to be included in a summary report. Further, ADSL information may be retrieved and included in the summary report. Exemplary embodiments are utilized to communicate this information to various organizations primarily during an emergency situation (e.g., hurricane) but may be used at any time that weather or other events have the potential to cause network outages.

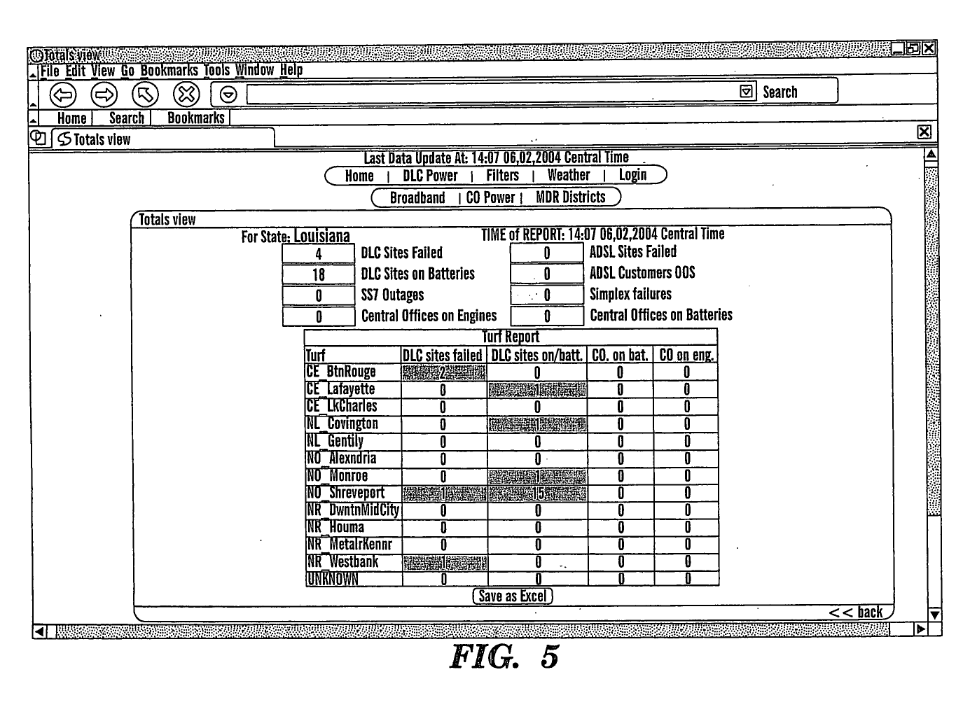

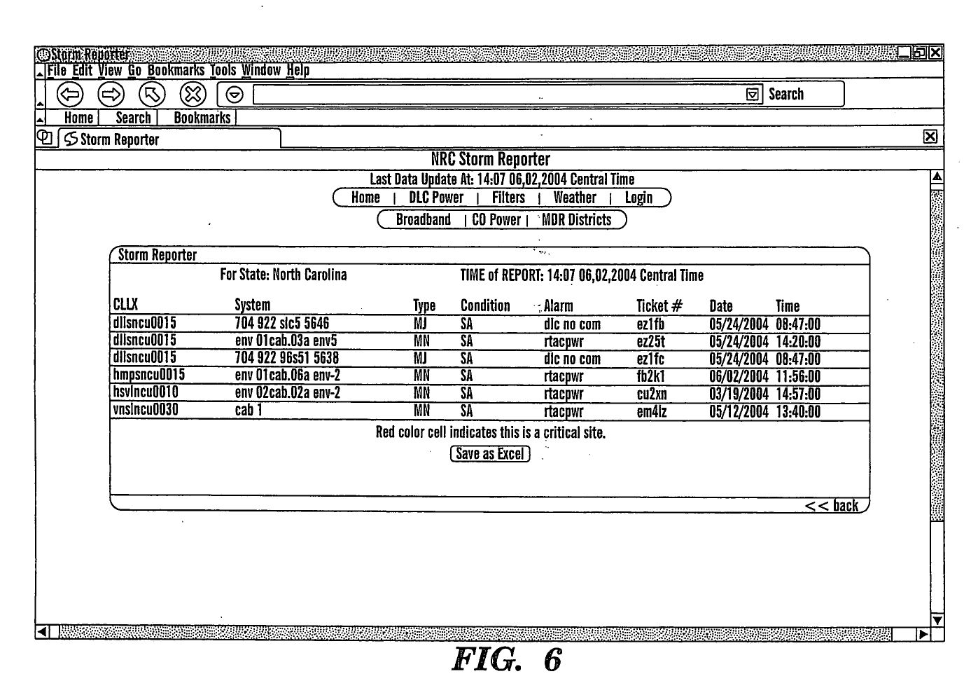

As depicted in FIG. 4, the home page includes the date and time of the last data collection 402. In exemplary embodiments, the alarm data is collected every thirty minutes. The navigation buttons 404 (home, DLC power, filters, weather, login, broadband, CO power and MDR districts) will be discussed further herein. The information section 406 is utilized to publish relevant information such as “the eye of the storm is expected to make landfall near Charleston, S.C. at 7 AM” or “the emergency control center (ECC) conference call is scheduled for this afternoon at 5 PM EST.” The active events section 408 contains links to a predefined filter for a named event. The “totals” link opens up a summary for a given state such as the one depicted in FIG. 5 below. The “DESS list” link opens up a DESS alarm view such as the one depicted in FIG. 6 below. In alternate exemplary embodiments, the main page includes access to a notepad associated with a particular storm event (also referred to herein as an event). The notepad may be utilized to record significant events, dates and times associated with the storm event as well as FWG names and numbers.

FIG. 5 is an exemplary user interface for a summary report of network outages for a selected state. The totals page depicted in FIG. 5 contains: DLC sites failed, DLC sites on batteries, COs on emergency generator or batteries, ADSL sites failed, ADSL customers out of service (OOS), SS7 outages, and simplex or failed interoffice carrier failures. The turf report table lists the DLCs, ADSLs and CO information by turf. A turf represents a geographic location and each state typically contains more than one turf. Each turf may be serviced by a different FWG. At the bottom of this user interface is a link to save the information, for example, into an Excel spreadsheet.

If the number of alarms at a particular site (identified by a site identifier) is more than a threshold (user modifiable) number of alarms (e.g., one, three, five), then an attribute of “failed” is associated with the site. In addition, sites without power for over twenty-four hours (number is user modifiable) may be highlighted, for example, in blue text.

FIG. 6 is an exemplary user interface for a detailed report for all DLCs in a selected state. A similar report may be created for other equipment types, such as all ADSLs or SS7s in a particular state or turf. FIG. 6, lists all DLC alarms as well as the date and time that the alarm came in, the alarm type and an NMA ticket number (e.g., from the NMA system discussed previously). The NMA ticket number is a unique 5 character code assigned by NMA to each alarm(s) that have reached a threshold. NMA ticket number is used to reference alarms. In exemplary embodiments, if a site has an alarm type of “rtacpwr” (power outage, or outage) or “rtaccrit” (critical) then it will be displayed in red lettering. Again, there is a link at the bottom of the page to save the data, in this case in an Excel spreadsheet. The code common language location identifier (CLLI) in FIG. 6 identifies physical locations and equipment such as buildings, COs, and antennas. In exemplary embodiments the CLLI is utilized as the site identifier.

The system column in FIG. 6 refers to DLC cabinet or NPA/NXX or system number. The type refers to critical or major or minor alarm. The condition refers to service affecting or non-service affecting alarm. The alarm refers to the alarm type and include values such as, but not limited to: out of service, power outage, on batteries, on engines and critical.

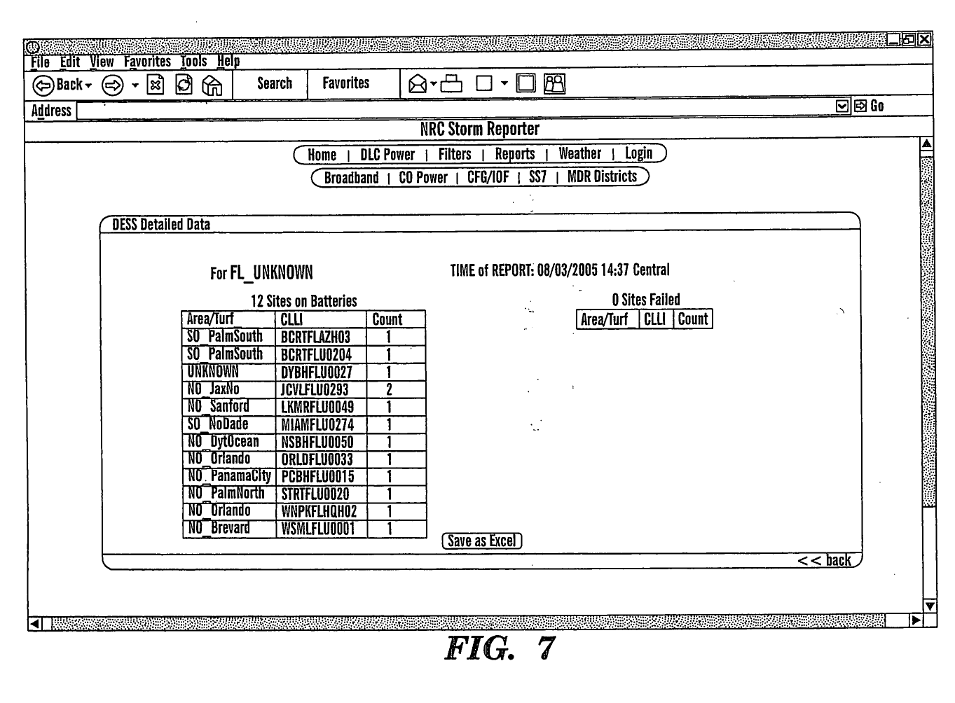

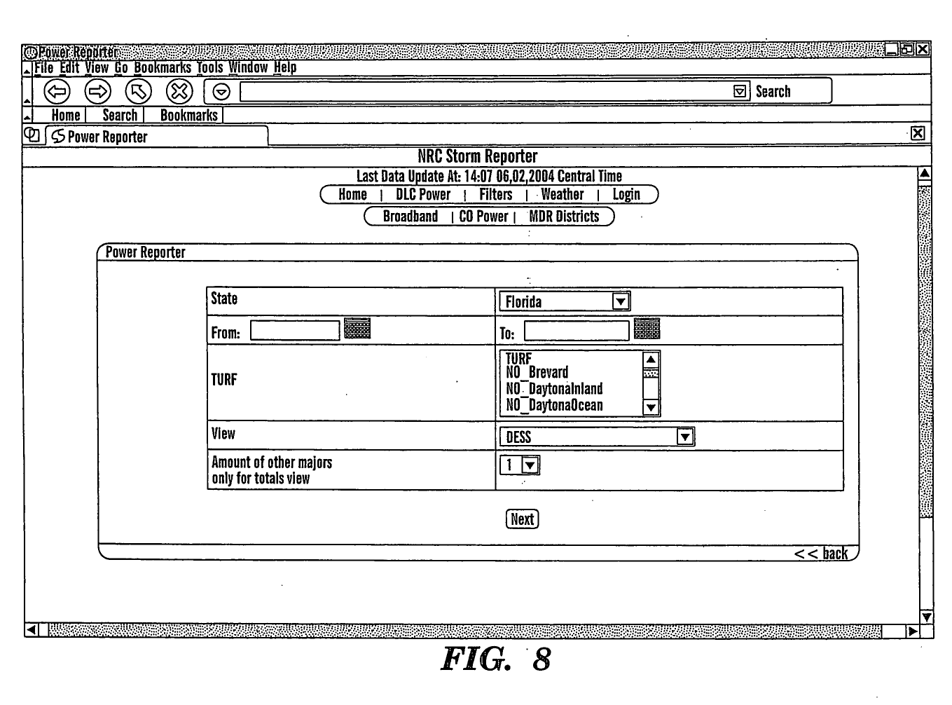

FIG. 7 is an exemplary user interface for DLCs failed or on batteries or failed. FIG. 8 is an exemplary user interface for viewing DLC alarms that are presented to the requestor after the requestor selects the DLC power navigation button 404 on FIG. 4. This DLC power link allows a requester, via a user system 104, to view DLC alarms. The requestor selects a state, a start and end date (if no dates are specified then all dates will be pulled), a turf(s) desired (if none are selected all will be pulled), either DESS or sites failed/on batteries for view, the amount of other majors (this is the number of additional alarms the program uses to determine if a site is failed). For example, if the amount of other majors is 1, then an error type of “rtacpwr” plus one other alarm (may require a major type of alarm) for that site to be counted as failed. A major alarm refers to a service affecting alarm condition.

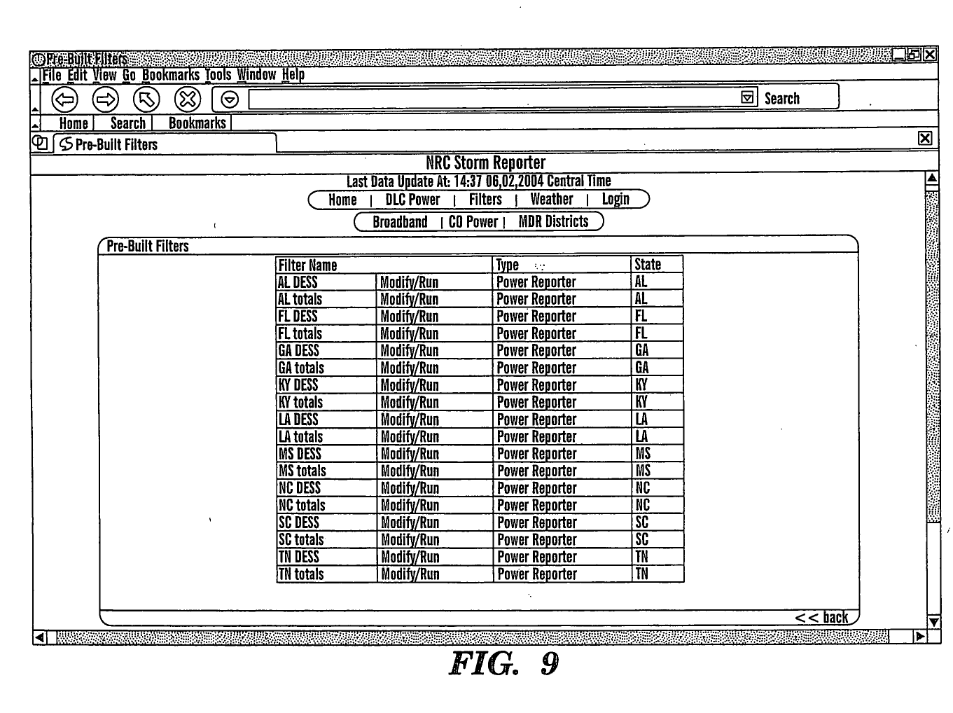

FIG. 9 is an exemplary user interface for viewing a list of predefined filters/reports that is presented to the requestor after the requester selects the filters navigation button 404 on FIG. 4. Two filters/reports are defined for each state: a DESS report for detailed analysis, and a totals report. The requester, with the proper authority, may initiate the execution of any of these filters/reports. The requester is presented with a link to a national weather service website when the weather navigation button 404 on FIG. 4 is selected. In addition, the requestor is presented with a logon screen (for access to advanced features such as the building of filters, events, information, text, etc.) when the login navigation button 404 is selected on FIG. 4. Most requestors will not require access to the advanced features. Further, the requestor is presented with the detailed ADLS alarm data when the requester selects the broadband navigation button 404 on FIG. 4. In exemplary embodiments, the ADSL alarm data is automatically retrieved (or received) from a network monitoring system.

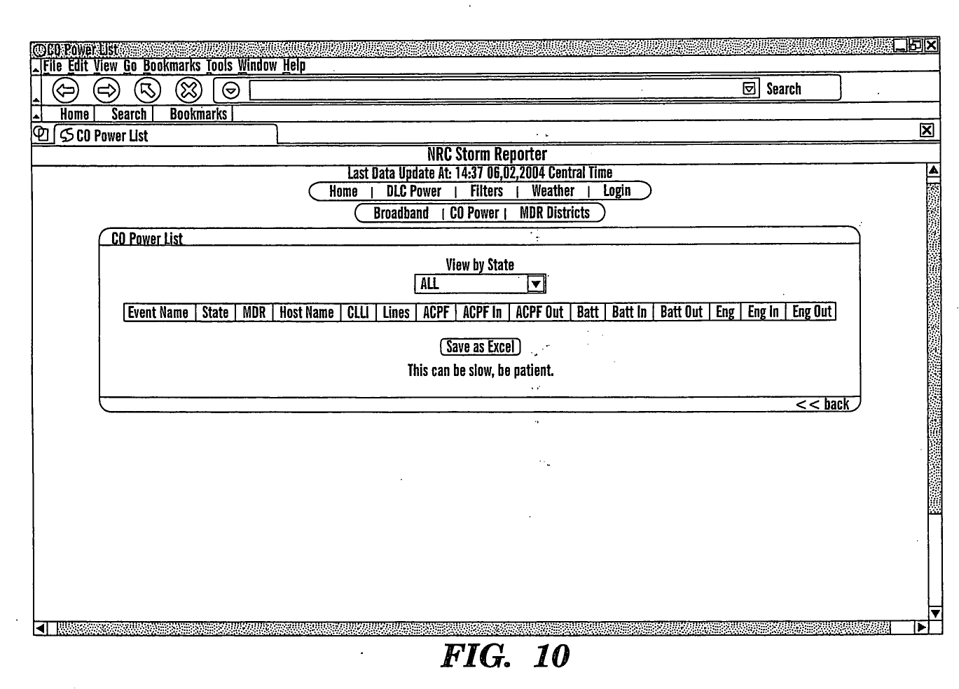

FIG. 10 is an exemplary user interface for viewing central offices on emergency power that have been selected to be included in a report and is presented to the requestor in response to the requester selecting the CO power navigation button 404 on FIG. 4. The CO power link, depicted in FIG. 10 displays offices on emergency power that have been selected to be included in the current report or in the report data. In exemplary embodiments, the alarm test group is able to search for offices on engines or batteries and select an insert button if the office is to be included in the report. For example, if a hurricane hits in Wilmington, N.C., but a power technician in Asheville, N.C. is performing a routine engine run, the Asheville site should not be included in the network outage report.

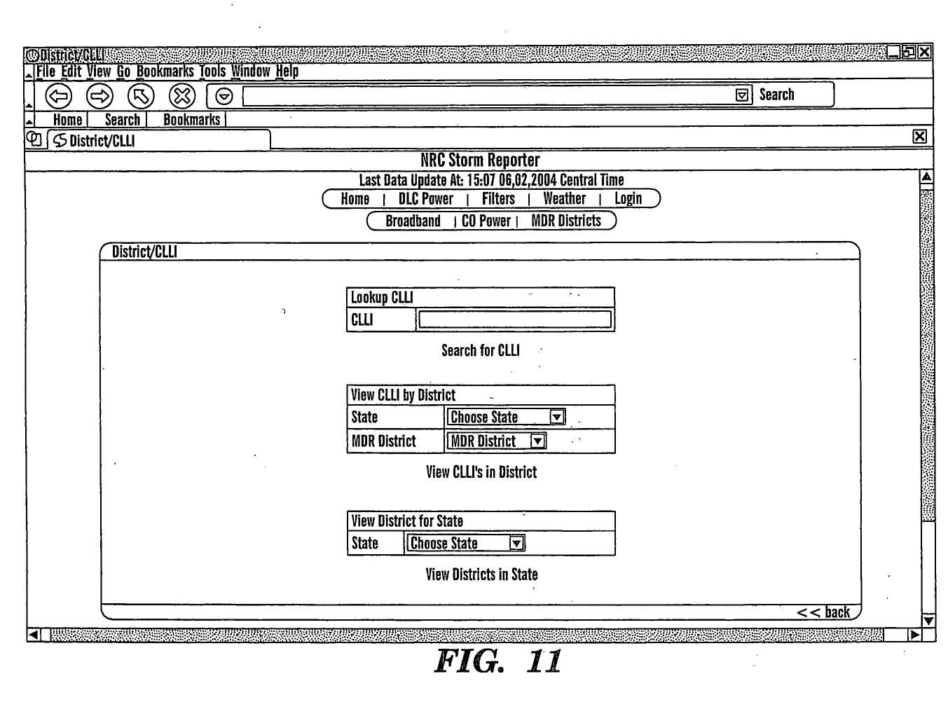

FIG. 11 is an exemplary user interface for allowing users to search for field work group (FWG) turf districts. The user interface depicted in FIG. 11 is presented to the requestor when the requestor selects the Mechanized Disaster Reporting District (MDR). A district is a geographic area defined by field work group management. District is the area of responsibility for that management organization districts navigation button 404 on FIG. 4. This user interface allows requestors to search for FWG turf district by CLLI, state or by listing all CLLI's for a district. In exemplary embodiments, the determination of turfs has been automated.

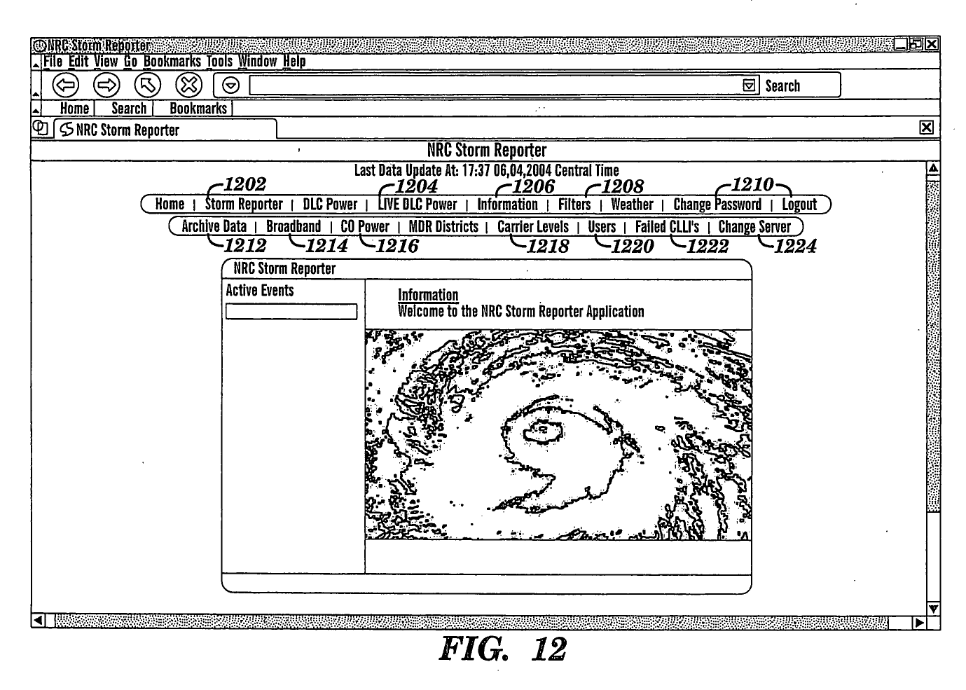

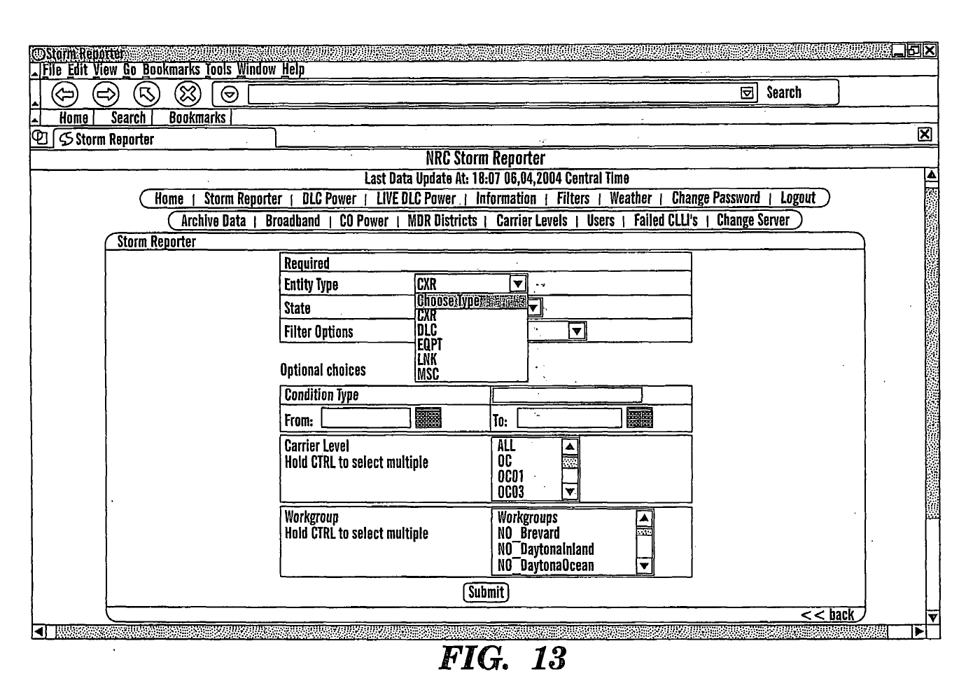

FIG. 12 is an exemplary user interface for advanced storm reporter functions only available to authorized user in exemplary embodiments. The user interface depicted in FIG. 12 is presented to the requester when the requestor selects the login navigation button 404 on FIG. 4 and successfully logs on (e.g., has an authorized password/userid). The selections from FIG. 12 include: a storm reporter option 1202; a live DLC power option 1204, an information option 1206 for updating the information section 406, a filter option 1208, a change password and logout option 1210, an archive data option 1212, a broadband option 1214, a CO power option 1216, a carrier level option 1218, a users option 1220, a failed CLLIs option 122 and a change server option 1224. The details of several of these options are discussed below in reference to FIGS. 13-19.

FIG. 13 is an exemplary user interface for searching alarms by entity type that is presented to the requestor when the requester selects the storm reporter option 1202. The storm reporter link allows requestors to search alarms by entity type, such as, but not limited to: carrier (CXR), DLC, equipment (EQPT), link (LNK) and miscellaneous (MSC). The entity type may contain values such as, but not limited to, NMA carrier, DLC, or miscellaneous. The carrier level refers to the North American Digital/SONET Bandwidth Hierarchy OC3, OC12, OC48, OC192, etc. For example, the requester could select “show all Florida OC3 carrier alarms.”

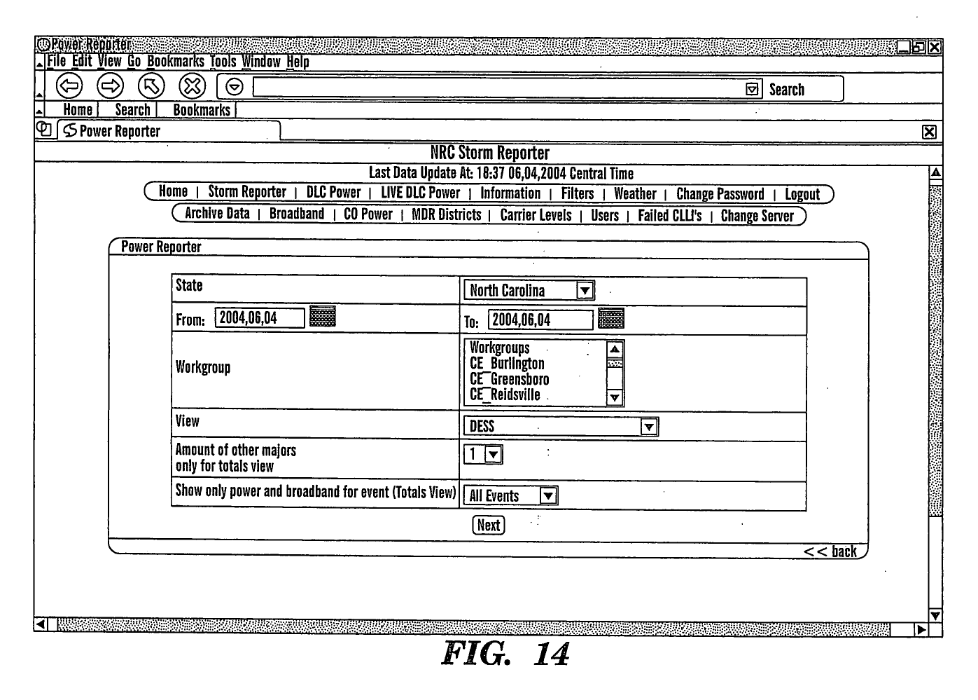

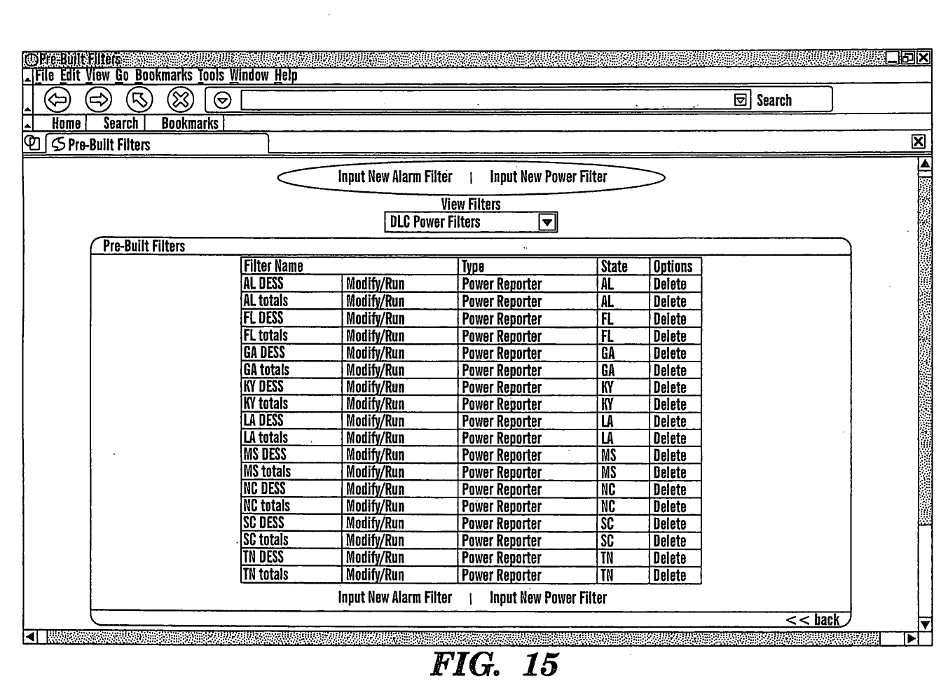

FIG. 14 is an exemplary user interface for viewing selected DLC alarms that is presented to the requestor when the requestor selects the live DLC power option 1204 on the user interface in FIG. 12. The user interface depicted in FIG. 14 is utilized to view live DLC alarms on demand from an alarm data source 110 (e.g., Telcordia NMA) that is providing DLC alarms to the system. This provides the requestor with a current view of alarms. FIG. 15 is an exemplary user interface for viewing and creating filters/reports that is presented to the requestor when the requester selects the filters option 1208 on the user interface in FIG. 12.

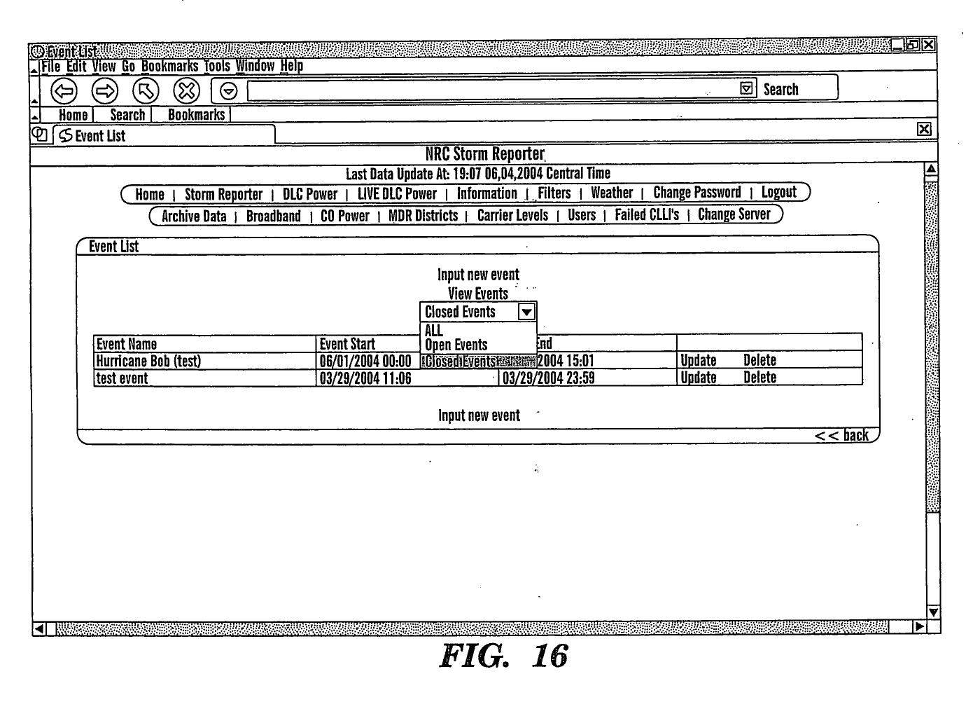

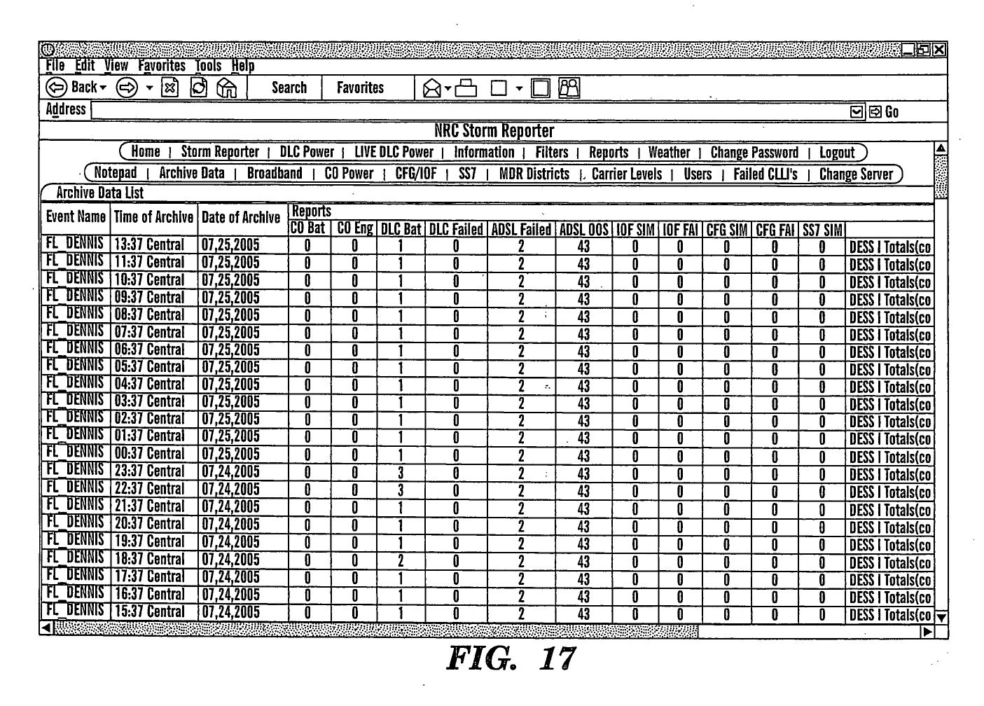

FIG. 16 is an exemplary user interface for viewing data relating to open and/or closed events that is presented to the requester when the requestor selects the archive data option 112 from the user interface depicted in FIG. 12. The archive link allows the requestor to view all events, view open events or to view closed events. Events may also be updated or deleted. In exemplary embodiments, the archive data is displayed in such a way that the requestor can quickly see storm trends. For example, the user interface in FIG. 16 may be utilized to quickly answer the question “when was the peak of the storm and how many DLC sites and COs were without power at that time?” Data is saved hourly on active events. Totals view, DESS and DLC sites failed and on battery view are saved. Archived data also includes central office power, ADSL, SS7 and carrier information. FIG. 17 is an exemplary user interface for viewing archived data.

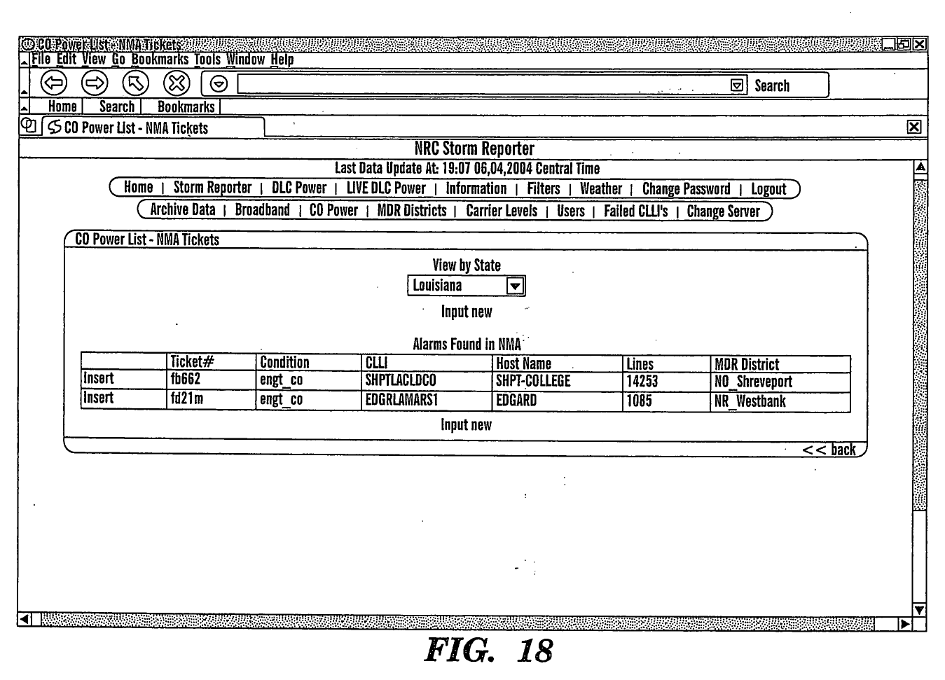

FIG. 18 is an exemplary user interface for inserting central office engine transfer and battery discharge alarms into a central office report. The user interface depicted in FIG. 18 is presented to the requester when the requester selects the CO power option 1216 from the user interface depicted in FIG. 12. The CO power page depicted in FIG. 18 allows requesters to view central office engine transfer data and battery discharge alarms and insert them (if due to the storm) into the CO power report (and into the report data).

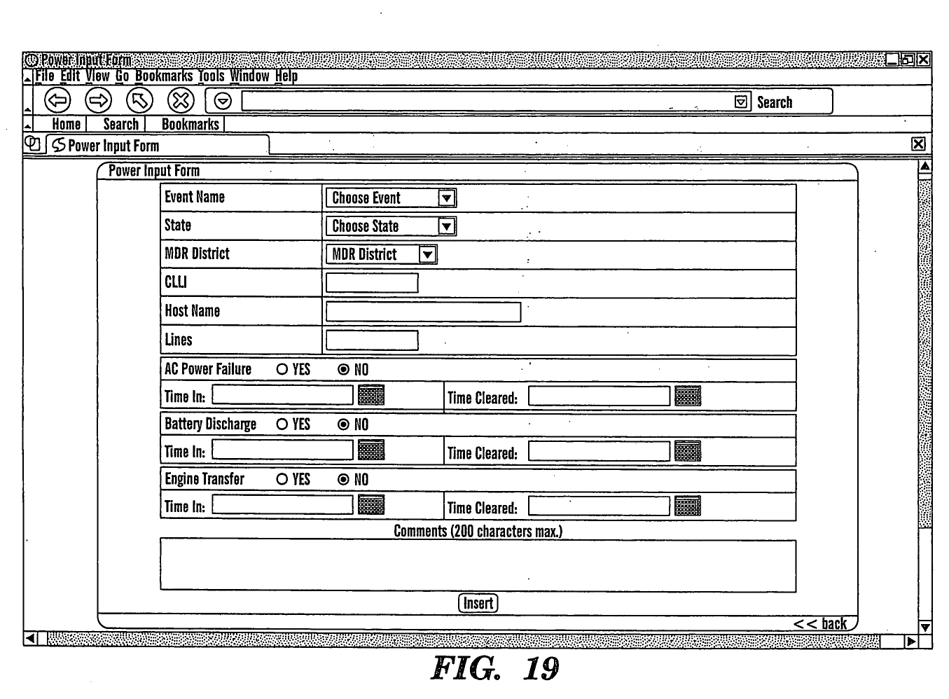

FIG. 19 is an exemplary user interface for manually entering CO engine transfer and battery discharge alarms for reporting that is also presented to the requester when the requestor selects the CO power option 1216 from the user interface depicted in FIG. 12. The CO power page also allows COs to be entered manually if they did not show up in the alarm data from the alarm data sources 110. For example, a requestor may learn that an office with a manual start generator has been placed on generator power and should be included in the report. It can be entered via the user interface depicted in FIG. 19.

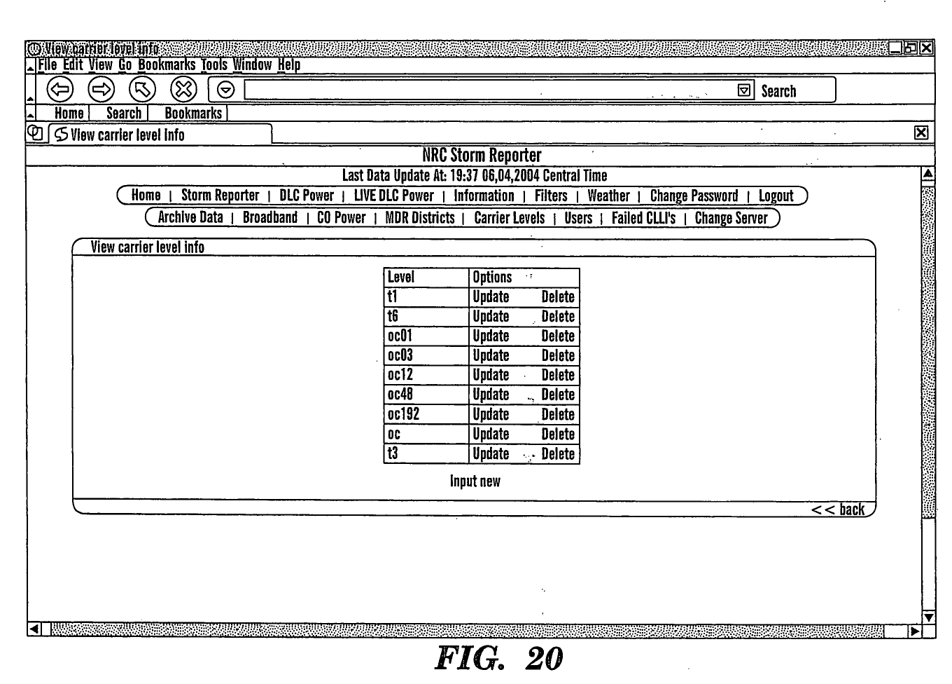

FIG. 20 is an exemplary user interface for updating and entering carrier levels. The user interface depicted in FIG. 20 is presented to the requestor when the requester selects the carrier levels option 1218 on the user interface depicted in FIG. 12.

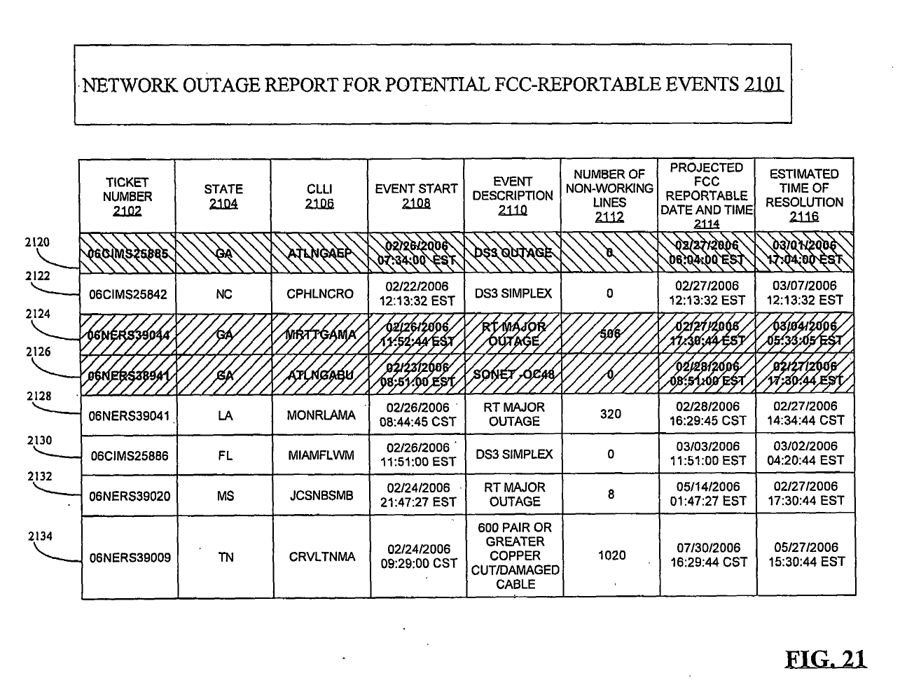

FIG. 21 is an exemplary user interface showing an illustrative network outage report for potential FCC reportable events 2101. The network outage report for potential FCC reportable events 2101 displays one or more network outage events which, in the present example, include outage events 2120, 2122, 2124, 2126, 2128, 2130, 2132, and 2134. Any of these outage events 2120-2124 has the potential to become an FCC reportable event if the outage event is not corrected in due course. For instance, if the outage causes more than a predetermined number of lines to fail, or if the outage lasts for longer than a predetermined duration, the outage event becomes a reportable event.

Each outage event 2120-2124 is associated with a corresponding ticket number 2102, state 2104, CLLI 2106, event start 2108, event description 2110, number of non-working lines 2112, projected FCC reportable date and time 2114, and estimated time of resolution 2116. Ticket number 2102 is a number assigned to an alarm record, or to a group of related alarm records, in order to facilitate resolution of an alarm condition by a field work group (FWG). Ticket number 2102 is assigned by a Customer Incident Measurement System (CIMS) or Network Event Reporting System (NERS). For example, outage event 2120 shows a ticket number 2102 of “06CIMS25885”, indicating that this ticket number was assigned by CIMS. On the other hand, outage event 2128 shows a ticket number 2102 of “06NERS39041”, indicating that this ticket number was assigned by NERS.

State 2104 indicates the geographic state or states in which the network outage has taken place. For example, outage event 2124 has taken place in the state of Georgia (GA), whereas outage event 2128 has taken place in the state of Louisiana (LA). CLLI 2106 indicates the common language location identifier for an outage event. More specifically, CLLI 2106 is an eight-character alphabetic or alphanumeric code that identifies a specific geographic location containing one or more switching devices.

Event start 2108 indicates a date and a time at which the network outage event first started. Outage event 2126 started on Feb. 23, 2006 at 8:51 EST. Event description 2110 contains a summarized description of a network outage, such as “DS3 Outage”, “DS3 Simplex”, “RT Major Outage”, “Sonet-OC48”, “600 pair or greater copper cut/damaged cable”, and others. Examples of other outage events include emergency 911 (E911) PSAPs that are out of service, E911 PSAPs that have been rerouted to an alternate location, failed telemetry involving a loss of dial tone to a significant percentage of customers, central offices where remote telemetry has failed, digital loop carriers (DLCs) that are operating on battery power, DLCs that have failed, and central offices that have failed.

Number of non-working lines 2112 indicates a number of communication lines or paths which are not functioning due to the outage event. Projected FCC reportable date and time 2114 indicates a date and a time at which an outage event will become a reportable event if the outage is not remedied. Estimated time of resolution 2116 indicates a date and a time by which an FWG or other entity is expected to remedy the outage event.

Outage event 2120 is associated with a first graphical indicia to show that this event has already become an FCC-reportable event. For example, outage event 2120 may be highlighted in red. Of course, a color other than red may be employed for this purpose, or a graphical indicia other than color may be used. Outage event 2120 could be shown in bold, associated with a graphical icon, displayed using a border, displayed using animated or blinking characters, or any of various combinations thereof, to show that this event has become an FCC-reportable event.

In the example of FIG. 21, a second graphical indicia is associated with events that are not yet FCC reportable, but which have crossed a user-defined threshold and may soon become FCC reportable. Use of the second graphical indicia is optional. For example, outage events 2124 and 2126 may be highlighted in blue or another color, or a graphical indicia other than color may be employed as discussed previously.

Outage event 2120 is associated with the first graphical indicia by defining a reportable event threshold in terms of a minimum reportable outage duration, or a minimum reportable quantity of lines affected by the outage, or both. Network outage information is retrieved comprising at least one of a current outage duration or a current quantity of lines affected by the outage. If the current outage duration is greater than the minimum reportable outage duration, or if the current quantity of lines affected by the outage is greater than the minimum reportable quantity of lines affected by the outage, a network outage report is generated which associates the outage with the first graphical indicia.

Optionally, a ratio is calculated between the current outage duration and the maximum permissible outage duration, or a ratio is calculated between the current quantity of lines affected by the outage and the maximum permissible quantity of lines affected by the outage. If the ratio exceeds a pre-reportable threshold but is less than one, the network outage report associates the outage, such as outage events 2124 and 2126, with the second graphical indicia. The network outage report is displayed on the output mechanism, printed by the output mechanism, or both.

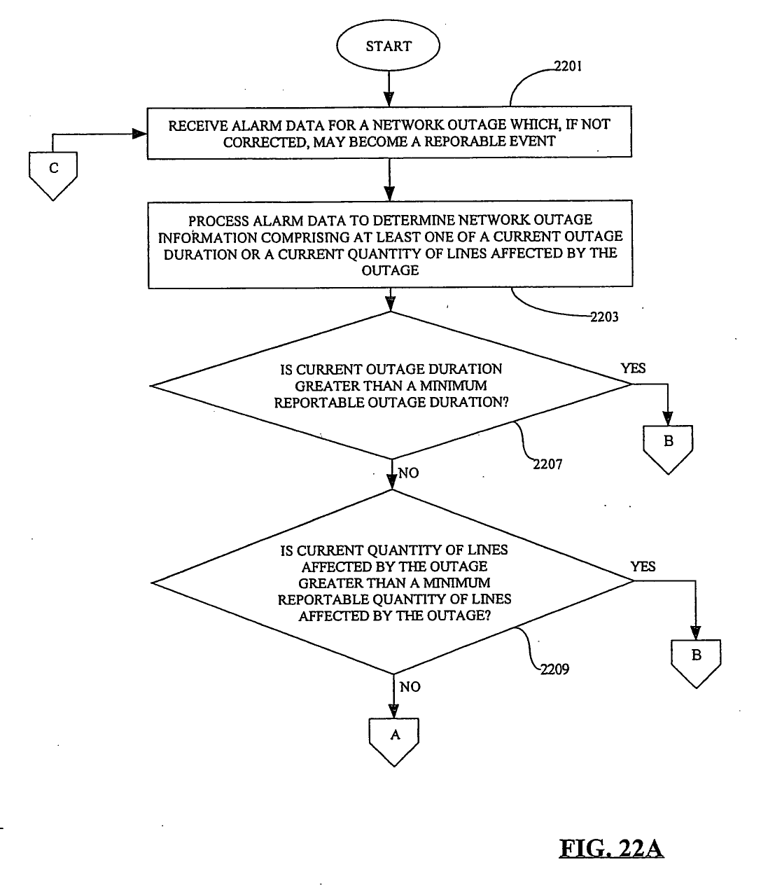

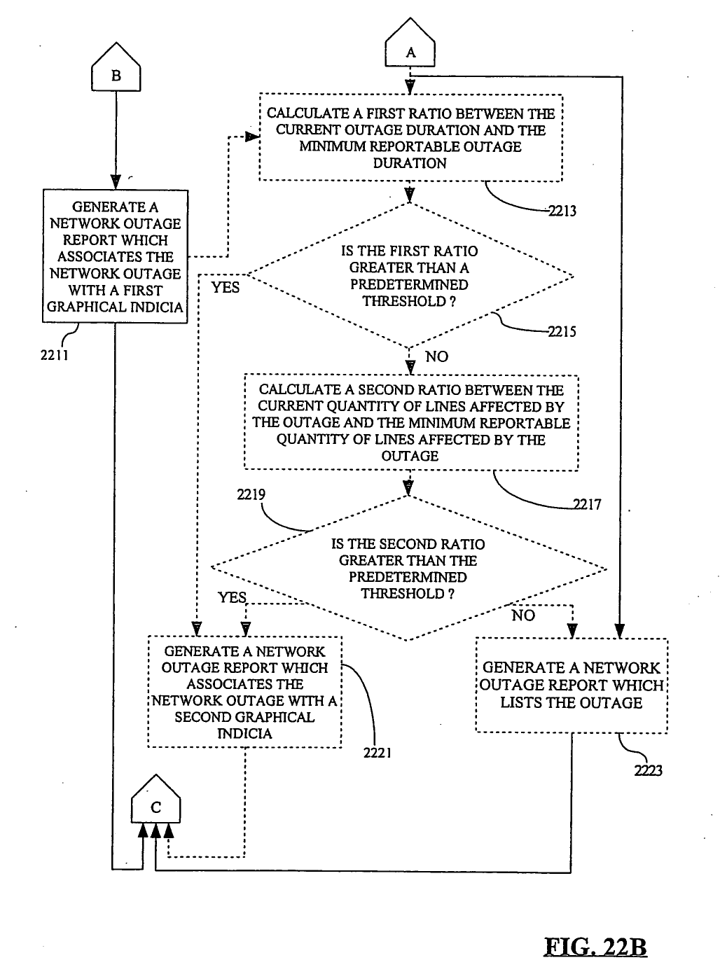

FIGS. 22A-22B together comprise an exemplary flowchart setting forth a process by which the network outage report of FIG. 21 may be generated. The process commences at block 2201 (FIG. 22A) where alarm data is received for a network outage which, if not corrected, may become a reportable event. At block 2203, alarm data is processed to determine network outage information comprising at least one of a current outage duration or a current quantity of lines affected by the outage. A test is performed at block 2207 to ascertain whether or not the current outage duration is greater than a minimum reportable outage duration. If so, the process advances to block 2211 (FIG. 22B), to be described in greater detail hereinafter. The negative branch from block 2207 (FIG. 22A) leads to block 2209 where a test is performed to ascertain whether or not the current quantity of lines affected by the outage is greater than a minimum reportable quantity of lines affected by the outage. If so, the process advances to block 2211 (FIG. 22B), to be described in greater detail hereinafter.

The negative branch from block 2209 (FIG. 22A) leads to optional block 2213 (FIG. 22B) or optional block 2223 or both. Optional block 2223 will be described in greater detail hereinafter. At optional block 2213, a first ratio between the current outage duration and the minimum reportable outage duration is calculated. At optional block 2215, a test is performed to ascertain whether or not the first ratio is greater than a predetermined threshold. The predetermined threshold can be user-selectable to meet the requirements of specific system applications. The affirmative branch from block 2215 leads to optional block 2221, to be described in greater detail hereinafter. The negative branch from block 2215 leads to optional block 2217 where a second ratio is calculated between the current quantity of lines affected by the outage and the minimum reportable quantity of lines affected by the outage.

Next, a test is performed at optional block 2219 to ascertain whether or not the second ratio is greater than the predetermined threshold. As stated previously, this predetermined threshold can be user-selectable to meet the requirements of specific system applications. The negative branch from block 2219 leads to optional block 2223 where a network outage report is generated, which lists the outage. The process then loops back to block 2201 (FIG. 22A). The affirmative branch from block 2219 (FIG. 22B) leads to optional block 2221 where a network outage report is generated, which associates the network outage with a second graphical indicia. As stated previously in connection with FIG. 21, the second graphical indicia may comprise highlighting the outage using a predesignated color such as blue, or another type of graphical indicia may be employed. The process then loops back to block 2201 (FIG. 22A).

The affirmative branches from blocks 2207 and 2209 lead to block 2211 (FIG. 22B) where a network outage report is generated, which associates the network outage with a first graphical indicia. As stated previously in connection with FIG. 21, the first graphical indicia may comprise highlighting the outage using a predesignated color such as red, or another type of graphical indicia may be employed. The process then loops back to block 2201 (FIG. 22A).

The user interfaces depicted and described herein are exemplary in nature, and many other user interfaces and data arrangements may be implemented based on the alarm data being received from alarm data sources 110 and on the requestor requirements. In exemplary embodiments the alarm data and report data are stored in databases (e.g., a relational database) that provide tools for manipulating and presenting data to the requestor.

Exemplary embodiments may be utilized to provide equipment status to any network provider (e.g., telephone company). Exemplary embodiments may not only be utilized to control and advise the network provider team during times of disasters, but they can also be used individually when severe weather is in any given area. Reports can be run at the request of any individual that has permission to view the data. In addition, exemplary embodiments provide for the storage of historical data for queries that may be required later for reports to government agencies.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for generating network outage reports, the method comprising:
receiving alarm data for a network outage which, if not remedied, may become a reportable event, wherein the alarm data includes a plurality of alarm records each including a site identifier, a date, a time, and an outage event description;
processing the alarm records to determine outage information comprising at least one of a current outage duration or a current quantity of lines affected by the outage, wherein a reportable event threshold defines at least one of a minimum reportable outage duration or a minimum reportable quantity of lines affected by the outage; and
if the current outage duration is greater than the minimum reportable outage duration, or if the current quantity of lines affected by the outage is greater than the minimum reportable quantity of lines affected by the outage, or both, then generating a network outage report which associates the network outage with a first graphical indicia.

2. The method of claim 1 wherein the first graphical indicia comprises at least one of highlighting the network outage with a first predesignated color, displaying the network outage in bold, associating the network outage with a first graphical icon, displaying the network outage using a border, displaying the network outage using animated or blinking characters, or any of various combinations thereof, to thereby indicate that the network outage has become an FCC-reportable event.

3. The method of claim 2 further including:
calculating a ratio between the current outage duration and the minimum reportable outage duration, or calculating a ratio between the current quantity of lines affected by the outage and the minimum reportable quantity of lines affected by the outage, or both; and
if the ratio exceeds a user-defined, pre-reportable threshold but is less than one, then generating a network outage report which associates the network outage with a second graphical indicia.

4. The method of claim 3 wherein the second graphical indicia comprises at least one of highlighting the network outage with a second predesignated color, displaying the network outage in bold, associating the network outage with a second graphical icon, displaying the network outage using a border, displaying the network outage using animated or blinking characters, or any of various combinations thereof, to thereby indicate that the network outage is about to become an FCC-reportable event.

5. The method of claim 4 further including using the network outage information and the reportable event threshold to predict a date and a time when the network outage will become a reportable network outage.

6. The method of claim 1 further including displaying the network outage report.

7. The method of claim 1 further including printing the network outage report.

8. A computer program product for generating network outage reports, the computer program product comprising a storage medium readable by a processing circuit and storing instructions for execution by the processing circuit for facilitating a method comprising:
receiving alarm data for a network outage which, if not remedied, may become a reportable event, wherein the alarm data includes a plurality of alarm records each including a site identifier, a date, a time, and an outage event description;
processing the alarm records to determine outage information comprising at least one of a current outage duration or a current quantity of lines affected by the outage, wherein a reportable event threshold defines at least one of a minimum reportable outage duration or a minimum reportable quantity of lines affected by the outage; and
if the current outage duration is greater than the minimum reportable outage duration, or if the current quantity of lines affected by the outage is greater than the minimum reportable quantity of lines affected by the outage, or both, then generating a network outage report which associates the network outage with a first graphical indicia.

9. The computer program product of claim 8 wherein the first graphical indicia comprises at least one of highlighting the network outage with a first predesignated color, displaying the network outage in bold, associating the network outage with a first graphical icon, displaying the network outage using a border, displaying the network outage using animated or blinking characters, or any of various combinations thereof, to thereby indicate that the network outage has become an FCC-reportable event.

10. The computer program product of claim 9 further including instructions for:
calculating a ratio between the current outage duration and the minimum reportable outage duration, or calculating a ratio between the current quantity of lines affected by the outage and the minimum reportable quantity of lines affected by the outage, or both; and
if the ratio exceeds a user-defined, pre-reportable threshold but is less than one, generating a network outage report which associates the network outage with a second graphical indicia.

11. The computer program product of claim 10 wherein the second graphical indicia comprises at least one of highlighting the network outage with a second predesignated color, displaying the network outage in bold, associating the network outage with a second graphical icon, displaying the network outage using a border, displaying the network outage using animated or blinking characters, or any of various combinations thereof, to thereby indicate that the network outage is about to become an FCC-reportable event.

12. The computer program product of claim 11 further including instructions for using the network outage information and the reportable event threshold to predict a date and a time when the network outage will become a reportable network outage.

13. The computer program product of claim 8 further including instructions for displaying the network outage report.

14. The computer program product of claim 8 further including instructions for printing the network outage report.

15. A system for generating network outage reports, the system comprising:
an output mechanism and a processor in communication with the output mechanism;
the processor including instructions for receiving alarm data from a plurality of sources for a network outage which, if not corrected, may become a reportable event, wherein the alarm data includes a plurality of alarm records each including a site identifier, a date, a time, and an outage event description;
the processor also including instructions for processing the alarm records to determine network outage information comprising at least one of a current network outage duration or a current quantity of lines affected by the network outage, wherein a reportable event threshold defines at least one of a minimum reportable outage duration or a minimum reportable quantity of lines affected by the network outage; and if the current outage duration is greater than the minimum reportable outage duration, or if the current quantity of lines affected by the outage is greater than the minimum reportable quantity of lines affected by the outage, or both, then generating a network outage report which associates the network outage with a first graphical indicia.

16. The system of claim 15 wherein the first graphical indicia comprises at least one of highlighting the network outage with a first predesignated color, displaying the network outage in bold, associating the network outage with a first graphical icon, displaying the network outage using a border, displaying the network outage using animated or blinking characters, or any of various combinations thereof, to thereby indicate that the network outage has become an FCC-reportable event.

17. The system of claim 16 wherein the processor further includes instructions for:
calculating a ratio between the current outage duration and the minimum reportable outage duration, or calculating a ratio between the current quantity of lines affected by the outage and the minimum reportable quantity of lines affected by the outage, or both; and
if the ratio exceeds a user-defined, pre-reportable threshold but is less than one, generating a network outage report which associates the network outage with a second graphical indicia.

18. The system of claim 17 wherein the second graphical indicia comprises at least one of highlighting the network outage with a second predesignated color, displaying the network outage in bold, associating the network outage with a second graphical icon, displaying the network outage using a border, displaying the network outage using animated or blinking characters, or any of various combinations thereof, to thereby indicate that the network outage is about to become an FCC-reportable event.

19. The system of claim 18 wherein the processor further includes instructions for using the network outage information and the reportable event threshold to predict a date and a time when the network outage will become a reportable network outage.

20. The system of claim 15 further including an output mechanism for at least one of printing the network outage report or displaying the network outage report.
